(19) United States
(12) Patent Application Publication
(10) Pub. No.: US 2002/0103770 A1
(43) Pub. Date: Aug. 1, 2002

(54) Performance counters for mail handling systems

(75) Inventors: Michael J. Ramadei, Trumbull, CT (US); Gary S. Jacobson, Norwalk, CT (US)

Correspondence Address: Pitney Bowes Inc., Intellectual Property and Technology Law Dept., 35 Waterview Drive, P.O Box 3000, Shelton, CT, 06484, US

(73) Assignee: Pitney Bowes Incorporated, Stamford, CT (US)

(21) Appl. No.: 09/775,419

(22) Filed: Feb. 1, 2001

(51) Int. Cl. G06F 17/00

(52) U.S. Cl. 705/406

(57) ABSTRACT

In a mechanical system, especially a mail handling system, an operator needs a system and method for gathering runtime information from sensors distributed throughout the machine. Specific information gathered is the number of recoverable faults for various mechanical subsystems, or modules. A recoverable fault is an occurrence of a motion state that could result in a malfunction or jam in the mechanical system but ultimately does not. These near-misses are important to note in order to improve serviceability of the mechanical system. Moreover, the present invention cross-links the data gathered by performance counters with respect to one module with information obtained in other modules. By taking the performance counter data and module information, an operator can foresee where potential malfunctions or jams are likely to occur.

### FIELD OF THE INVENTION

The present invention relates to performance counters for controlling the operation of mechanical systems. More particularly, it relates to performance counters particularly suited for paper handling systems.

### BACKGROUND OF THE INVENTION

Vital to the operation of businesses today is a smooth and efficient mailroom. Mailrooms utilize various automated handling machines developed for processing mail (removing individual pieces of mail from a stack and performing subsequent actions on each individual piece of mail). These automatic mail handling machines process and handle “mixed mail.” The term “mixed mail” is used herein to mean sets of intermixed mailpieces of varying sizes (postcards to 941 by 14″ flats), thickness, and weights. In addition, the term “mixed mail” also includes stepped mail (i.e., an envelope containing therein an insert which is smaller than the envelope to create a step in the envelope), tabbed and untabbed mail products, and mailpieces made from different substrates. Thus, the range of types and sizes of mailpieces which must be processed is extremely broad. The breadth of the mailpieces may lead the mail processing machines to experience problems such as malfunctions or jams. Whenever the machines experience problems, the efficiency of the entire mailroom is compromised. Thus, it is in the best interest for these mail handling systems to run as continuously and efficiently as often as possible.

Currently, problems are often not diagnosed until a malfunction or jam actually occurs. Efficiency can be increased if machine degradation is tracked to predict and isolate subsystems, or modules, on a mail handling system that are prone to failure. The present invention identifies recoverable faults that may cause problems but do not necessarily result in an immediate malfunction or jam during the operation of the machine. These recoverable faults are tracked by software-based performance counters that monitor key variables used to determine how the machine is operating.

To detect potential problems, a system is needed to record the number of recoverable faults in a particular module. Performance counters may be implemented to count the number of mailpieces that experience a recoverable fault as well as the total number of mailpieces processed by a module. The system also cross-links the recoverable faults in one particular module to information gathered from other modules. This provides a more comprehensive view of machine operation. By comparing the performance counter logs against expected operating ranges of normal operation, a more accurate understanding of machine operation is obtained. All of the logs can be outputted in a format that can be understood by a human or machine, for example a visual display, printer or machine file.

Although performance counters are known in the art, such counters will record only malfunctions and jams. Additionally, these counters will blindly log all data generated by the machine sensors. The logs are often designed without regard to data reduction. The operator, thus, has the burden to sift through all the data and determine relevance. Moreover, these logs are limited in that they are binary. The log will record all or nothing data, i.e., either the machine is operational or is jammed. Additionally, these logs tend to be produced without regard to the data being generated by other modules within the machine. Thus, the prior art does not cross-link information gathered from one module to information gathered by another module. This cross-linking of data is especially important for mechanical systems that contain multiple modules that share a common platform with no easily discernable boundaries. Often jams will manifest themselves downstream of where a problem originated; and, if a system is too focused only on a single module, then any diagnosis of the machine would begin in the wrong place.

A need thus exists for a system for gathering runtime information by using performance counters to record relevant faults resulting in a reduction of data. An operator can review the log and predict where a malfunction or jam is likely to occur in the future. The responsible modules can be serviced when the machine is not in operation, thus improving the runtime of the machine.

Additionally, a need exists for a system that can cross-link information from other modules to performance counter data from a particular module.

A need also exists for a system for gathering runtime information that includes timestamping of when a recoverable fault occurs, and the specific job run that experienced the fault that allows the operator to trace what types of or specific mailpieces are responsible for the recoverable fault.

### SUMMARY OF THE INVENTION

In one aspect, the invention features a system for gathering runtime information from a mail handling system comprising: a component for maintaining a motion state in a mechanical system (i.e., maintained by a motion control processor), a component for incrementing a counter if the motion state meets criteria established in the motion profile, and a component for transferring the data contained in the counter to a log. In one embodiment, the system is used for a mixed mail feeder. In other embodiments, the criteria established are a function of time, cycle, or mechanism retry. Motion states include, but are not limited to, nudger retry, separator hesitation, overheight mailpieces, trap activation, nudger assistance, multi-feed, and take away roller assist. The counters can be incremented by a value of one, although any positive or negative value may be appropriate for the invention.

In another aspect of the invention, the invention features a system for gathering detailed runtime information from a mail handling system comprising a component for maintaining a motion state in a mechanical system, a component for identifying a module corresponding the motion state by the motion control processor, a component for incrementing a counter if the motion state meets the criteria established in the motion profile, a component for transferring the data contained in the counter to a log, and a component for transferring information regarding said module to the log. In one embodiment, the system further comprises a component for recording a timestamp when the motion state occurs.

In yet another aspect of the present invention, the invention features a method for gathering detailed runtime information from a mail handling system comprising the steps of maintaining a motion state in a mechanical system, incrementing a counter if the motion state meets criteria established in the motion profile, and transferring data contained in the performance counter to a log.

Moreover, the invention also features a method for gathering detailed runtime information from a mail handling system comprising the steps of maintaining a motion state in a mechanical system, identifying a module corresponding to the motion state by a motion control processor, incrementing a performance counter if the motion state meets criteria established in the motion profile, transferring data contained in the performance counter to a log, and transferring information regarding the module to the log.

By utilizing the present invention, the operator of a mechanical system can identify potential areas in the system that could result in recoverable faults. Unlike the prior art, the invention does not log in all mechanical failures or jams. The invention focuses on the logging of recoverable faults. This allows the logs to contain more selective data, thus improving the serviceability of the module system.

Another advantage of the system is that the software code used to create the motion profile allows for the control of mechanical system function and establishes the criteria used to determine whether the performance counter should be incremented. Thus, the function and the criteria are embedded in the motion profile making the system unique.

Other features and advantages of the present invention will be apparent from the detailed description of the invention and from the claims.

### BRIEF DESCRIPTION OF THE DRAWINGS

The accompanying drawings, which are incorporated in and constitute a part of the specification, illustrate a presently preferred embodiment of the invention, and together with the general description given above and the detailed description of the preferred embodiment given below, serve to explain the principles of the invention:

FIG. 1 is a block diagram that illustrates a system that utilizes the method of the present invention;

FIG. 2 is a schematic plan view of a mixed mail feeder, an exemplary mechanical system;

FIG. 3 is a flow diagram of steps of the method for using performance counters;

FIG. 4 is a flow diagram showing a motion profile to increment a hesitation performance counter for use in a separator module;

FIG. 5 is a flow diagram showing a motion profile to increment a trap activation performance counter for use in an aligner station module; and

FIG. 6 is a flow diagram showing a motion profile to increment a overheight mailpiece performance counter for use in an aligner station module.

### DETAILED DESCRIPTION OF THE PREFERRED EMBODIMENTS

The present invention relates to a system for gathering detailed runtime information from a mail handling system comprising the steps of maintaining a motion state by a motion control processor in a mechanical system, incrementing a performance counter if the motion state criteria established in the motion profile are met, and transferring the data contained in the counter to a log.

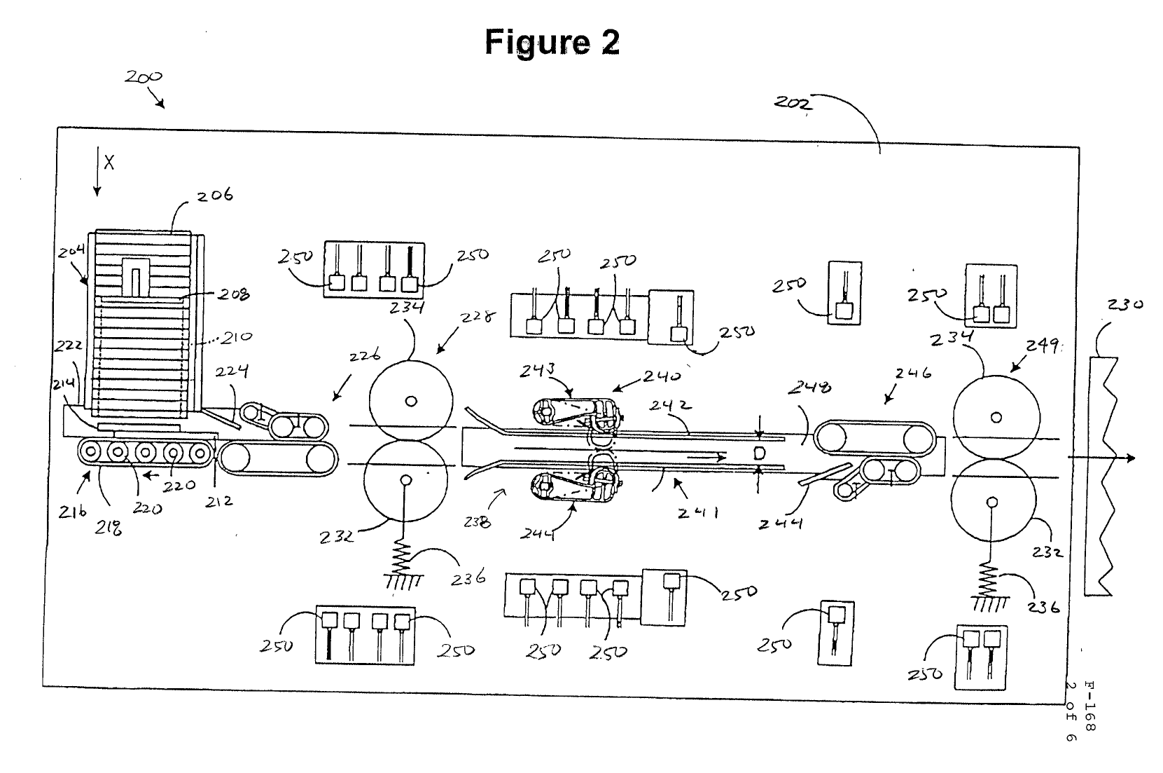

The present invention relates to performance counters that can be used in the control and operation of any mechanical system. Moreover, the present invention is particularly useful for mechanical systems such as paper handling systems which transport and perform operations on a work piece such as a sheet of paper, an envelope, or completed mailpiece. As shown in FIG. 2, mail handling systems that can be used in conjunction with the present invention include, but are not limited to, mixed mail feeders which separate individual mailpieces from a stack of mixed mail and transport the individual mailpiece to a subsequent mail processing station. Mail processing systems include, but are not limited to, a meter for printing postage on the mailpiece, an optical character recognition reader for reading addresses off of a mailpiece, a sorting device for sorting individual mailpieces to designated bins or areas, or a scale that weighs the mailpiece.

The performance of any mail handling system or mail processing system needs to be monitored, and the present invention does so. U.S. Pat. No. 5,644,486, incorporated herein by reference, discloses an apparatus for controlling a mechanical system in response to messages from a host computer system. The performance counters of the present invention can be incorporated into the system disclosed therein. In this manner, an apparatus for controlling a mechanical system in response to messages from a computer system can employ performance counters for mail handling/processing system monitoring.

### COMPUTER SYSTEM

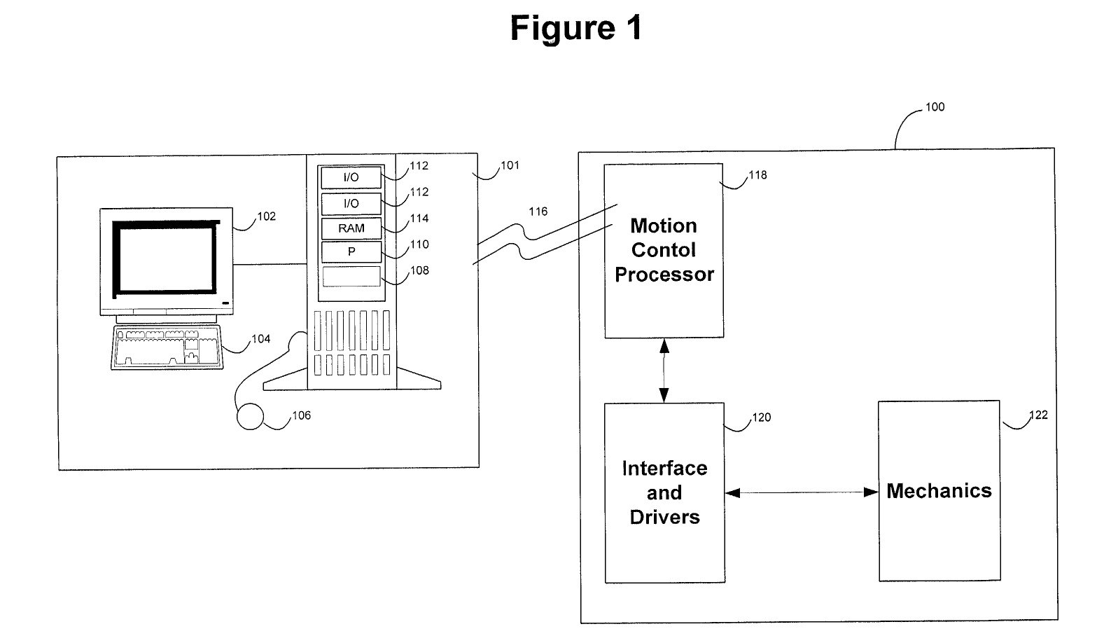

The present invention employs both a mechanical system (e.g., a mixed mail feeder 100) and a computer system 101. Referring to FIG. 1, computer system 101 may be a personal computer, which is used generically, and refers to present and future microprocessing systems with at least one processor operatively coupled to user interface, such as display 102 and keyboard 104, and/or a cursor control, such as a mouse or trackball 106, and storage media 108. The computer system 101 may be a workstation that is accessible by more than one user. The computer system 101 also includes a conventional processor 110 such as the Pentium™ processors manufactured by Intel, and conventional hard drive 108, floppy drive(s) 112, and memory 114. The computer system 101 is connected through communications link 116 to a motion control processor 118. Communications link 116 may be any suitable communications link having the necessary communications capacity, the details of which form no part of the present invention.

The mixed mail feeder 100 comprises the motion control processor 118, interface and drivers 120, and mechanics 122 of the system. The motion control processor 118 can be Hitachi model H8S/2655 processor, and is connected to control the mechanics 122 through interface and drivers 120.

Interface and drivers 120 comprise circuitry which converts the digital output of motion control processor 118 into control signals having the proper waveform and timing to control the mechanics 122.

### MECHANICAL SYSTEM

FIG. 2 is a simplified representation of the mechanics 200 of a mixed mail feeder. The mechanics 200 can be divided into the following modules: stack advance mechanism 204, nudger 218, the first separator 226, the first take away rollers 232, 234, the aligner station 238, the second separator 246, and the second take away rollers 249.

The mechanics 200 has a framework 202 upon which all of the components of the mechanics 200 are mounted. The mechanics 200 includes a stack advance mechanism 204 having a continuous belt 206 mounted for rotation about a plurality of pulleys (not shown) in the direction of arrow “X”. Mounted on the conveyor belt 206 is an upstanding stack advance paddle 208 which moves with the conveyor 206 in the direction of arrow “X”. In operation, a stack of mixed mail 210 is placed on the conveyor belt 206 and rests against the stack advance paddle 208. The stack of mixed mail 210 includes a lead mailpiece 212 and a second mailpiece 214. Thus, as the conveyor belt 206 is set into movement, the stack of mixed mail 210 is moved toward an input feed structure 216. Input feed structure 216 includes a nudger 218 which is a wall that includes a plurality of rollers 220 mounted therein to be freely rotatable. Accordingly, as the stack advance mechanism 204 forces the lead mailpiece 212 into contact with the nudger rollers 220, the lead mailpiece 212 is laterally moved away from the stack of mixed mail 210. Additionally, a driven belt 222, which makes contact with the bottom edge of the lead mailpiece 212, also assists in moving the lead mailpiece 212 downstream past a guide mechanism 224 and toward a first separator 226. The combination of the stack advance paddle 208, input feed structure 216, and the guide plate 224 present the mailpieces which are removed from the stack of mixed mail 210 into the first separator 226, that separates the lead mailpiece 212 from the remaining stack of mixed mail 210 so that only individual mailpieces are presented to the output feeding structure 228 for ultimate processing downstream to a mail processing system 230.

Output feed structure 228 includes take away rollers 232, 234 which receive the mailpiece as it exits the first separator 226 and transports it downstream. The take away rollers 232, 234, are more specifically idler roller 232 and drive roller 234. The idler roller 232 is spring loaded by spring 236 and is moveable toward and away from the drive roller 234 to accommodate different mailpiece thicknesses. The aligner station 238 directs the mailpieces into a vertical orientation and consists of two guide walls 241, 242. This ensures that the mailpieces are aligned on their bottom edge prior to transport past a second guide plate 244 and into a second separator 246. In the aligner station 238, the mailpieces are driven along their bottom edges by a transport belt 248. The aligner station 238 may include a trap subsystem 240 which provides gap enforcement between mailpieces. The trap 240 allows the transport belt 248 to remain in constant motion while an interpiece gap is being maintained or lengthened, instead of attempting to achieve the gap by stopping and starting the transport belt 248. Stopping and starting the transport belt 248 would stop all the mailpieces on the transport belt 248 instead of just the mailpieces between which a larger gap is desired. The gap is important because the mail handling system may need time for downstream processing in the mail processing system 230. The trap subsystem 240 comprises two trap levers 243, 244 which are actuated in order to grab a mailpiece as it moves through the aligner station 238.

After passage through the second separator 246 which has components and functionality like first separator 226 described above, the individual mailpieces are transported into a second set of take away rollers 249 which transport the individual mailpieces to the processing station 230. The second set of take away rollers 249 has the same structural components and functionality as the first set of take way rollers 228 described above.

Sensors 250 are mounted along the entire feed path of the machine. Each sensor 250 may be, for example, a photo electric sensor for detection of light, which when blocked, indicates that a mailpiece is on the transport belt in the area of the sensor 250. The sensor 250 configurations provided in FIG. 2 are exemplary; other configurations and types of sensors may be used by one of ordinary skill in the art.

### PERFORMANCE COUNTERS

As used herein, a segment is a data element including identification of any part of the mechanical system effected by the segment command (if any); a command to be executed by the motion control processor 118 during the segment; and any information required for execution of the segment command. A profile is a sequence of segments whose execution by a motion control processor 118 controls the mechanics 122 of a mechanical system to carry out a corresponding mechanical function.

The performance counters are segments of software code which reside in motion profiles that are embedded in the motion control processor 118. These motion profiles can be originally stored in the memory of the motion control processor 118 or downloaded from the computer system 101. The motion profiles contain both logic and data. The motion profiles are executed by the motion control processor 118. The motion control processor 118 maintains the state of the mechanical system and determines whether these states satisfy criteria established within the motion profile. Upon satisfaction of the criteria, a performance counter within the motion profile increments or documents. Thus, not only do the motion profiles control the mechanics of the mechanical system, they also monitor the performance of the system via the performance counters. This duality makes these profiles unique. Typically, the performance counters are uploaded at the end of a run of the mixed mail feeder and stored in the job record with other data. Because the motion profiles are initiated by the motion control processor 118, the profiles are identified with discrete motion states in the mechanical system. At the end of the job run, the data in the performance counters, as well as any other information regarding the job run, is transferred to the computer system 101. The computer system 101 is able to cross-link the data from the performance counters with other information from other modules.

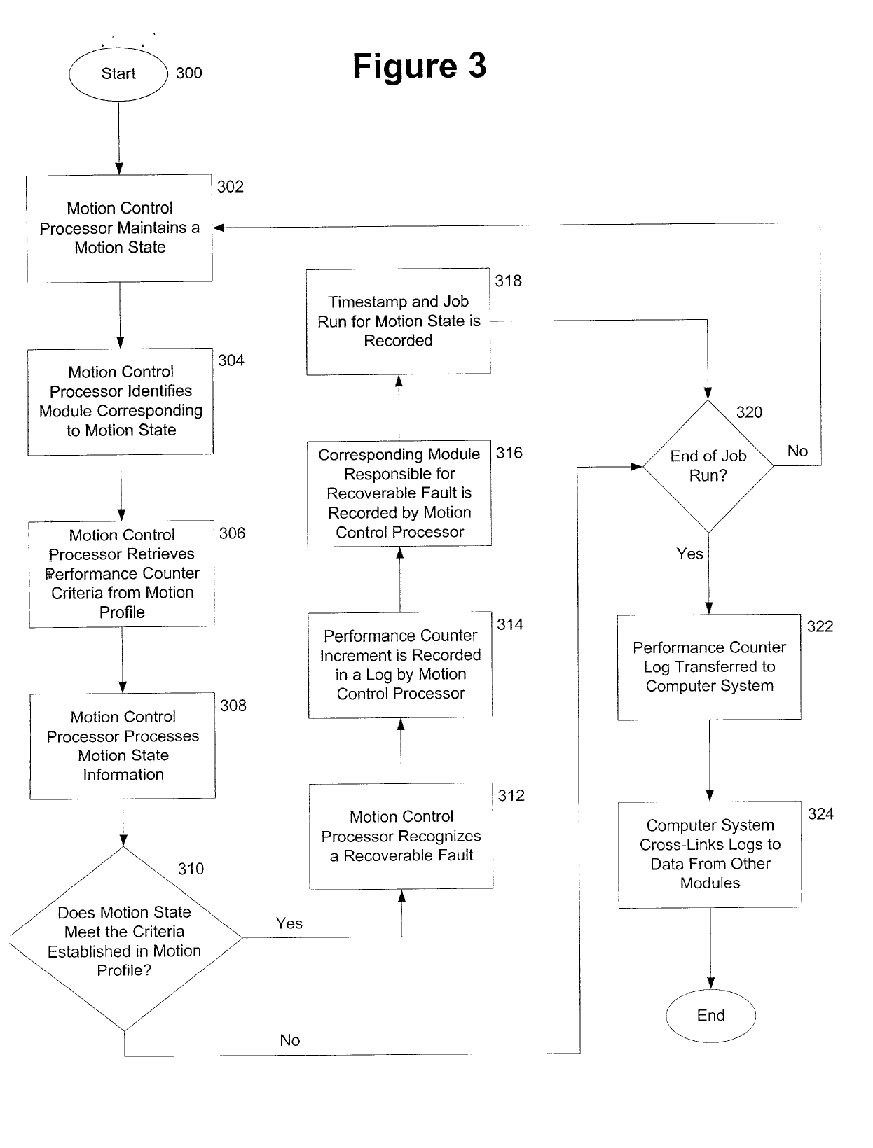

FIG. 3 depicts a flow diagram of the operation of the performance counters. At step 300, the motion control processor executes a motion profile for a module. At step 302, the motion control processor 118 maintains a motion state in the mixed mail feeder 100. The motion profile contains criteria that the motion state should meet. The criteria could be a function of time, for example, the time it takes for a mailpiece to proceed from the first separator 226 to the aligner station 238. The criteria could also be a function of cycle. For example, a cycle-based motion state is based on the processing of a single mailpiece. Each mailpiece that is processed is considered cycled. The criteria could also be a function of mechanical retry, for example, if a nudger 218 repeatedly attempts to send a mailpiece to the first separator 226. At step 304, the motion control processor 118 identifies the mechanical module(s) in the machine that corresponds to the motion state. For example, if a nudger 218 repeatedly tries to send a mailpiece to the aligner station 238, then this motion state would be matched with the nudger 218 and aligner station 238 modules. At step 306, motion control processor 118 retrieves the performance counter code within the motion profile corresponding to the motion state. By matching the motion state to the criteria in the motion profile, the motion control processor 118 is able to count near-misses or recoverable faults. In the example pertaining to the nudger 218, the motion profile may require the maximum amount of time for retries to be three hundred milliseconds and the maximum number of retries to be two. At step 308, the information is processed by the motion control processor 118. At step 310, a determination is made whether the motion state satisfies the criteria (e.g. retries exceed the allotted time or if there are more than two retries). If not, the motion control processor 118 proceeds to the next motion state. If the discrete motion state does exceed the predetermined criteria, there is a recoverable fault as in step 312. Once again, in the nudger 218 example, if the nudger 218 finally sends through the mailpiece after three attempts, then this value would be compared to the maximum attempt number of two as determined in the motion profile. Three attempts do satisfy the criteria, so the nudger 218 performance counter increments. Note that the motion profile identifies recoverable faults in addition to complete failures (i.e., a jam) such as a nudger 218 being unable to send the mailpiece through to first separator 226. At step 314, a performance counter used to monitor a specific module of the mixed mail system 100 is incremented or decreased by a certain value, for example by one if the criteria is met. The performance counter thus effectively counts the number of recoverable faults that occurred during the operation of the mechanics 200. Also at step 314, the increment in the counter is recorded by a log stored in the motion control processor 118. The counts for the nudger 218 example, would be recorded in a “Retry Performance Counter for the Nudger.” At step 316, along with the logging of the counter increment, the corresponding module is logged. In addition to this information, at step 318, a timestamp, the time and job the motion state occurs, and the mailpiece that caused the motion state can be recorded. This additional information aids in determining recoverable faults associated with other modules. In step 320, the computer system 101 then checks to see if the job run has ended; if not, it moves onto the next motion state. If it is the end of the job run, then at step 322, the log is transferred from the motion control processor 118 to the computer system 101. At step 324, the computer system 101 cross-links the log from the motion control processor 118 to logs from other parts of the mixed mail feeder. The information in other logs could be data regarding the physical properties of the type of mailpieces being processed (e.g., the length, height and thickness).

An analysis program can be written to post automatically and process the information contained in the database so that a composite picture of the operation of the mail processing system 100 is presented. This process has been used to analyze performance trends, allowing operators to predict impending failures as well as troubleshoot specific recoverable faults. This process is not a part of the invention itself; it merely serves to show the care and forethought put into making data reduction a priority. Last, the database or log information can be displayed on a computer display or printed in hard copy by a printer.

These logs and recoverable faults recorded therein can be viewed from two levels. The high, or first level, allows the operator to determine the number of recoverable faults attributed to each mechanical module of the mixed mail feeder 100. Upon closer examination, or second level, the operator can focus on the individual components of each module and identify the mailpieces that are responsible for the recoverable faults.

### Hesitation Performance Counter Profile for Separator Module

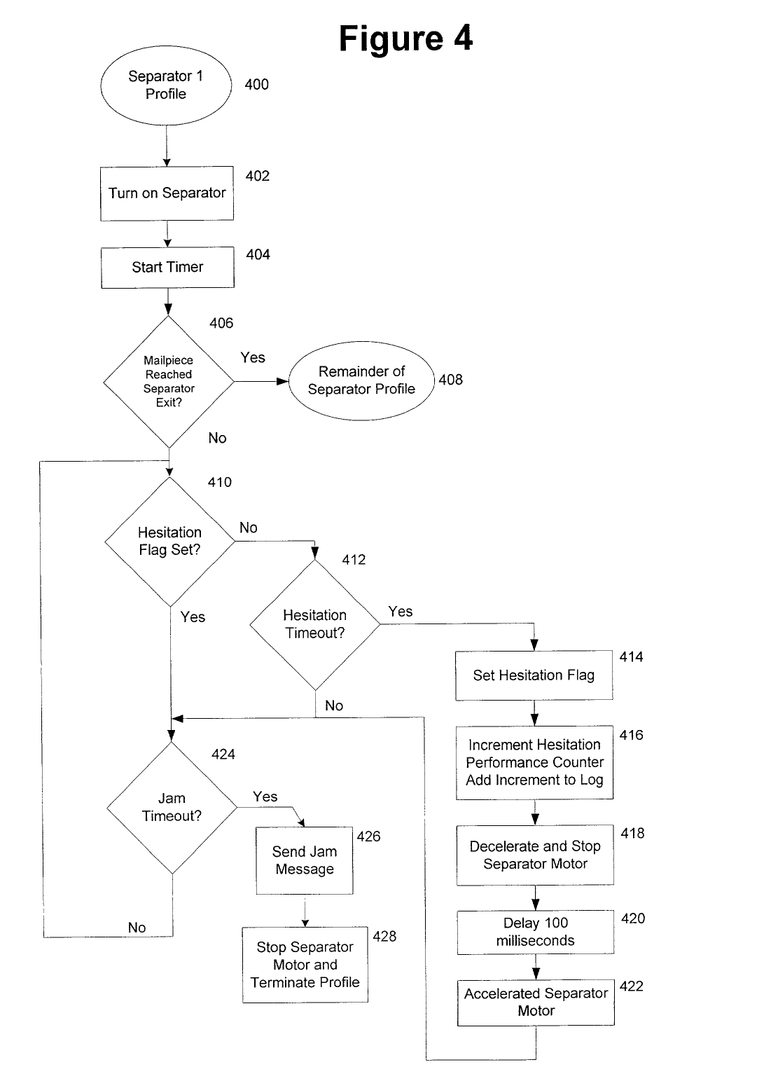

FIG. 4 depicts a hesitation performance counter profile for a separator, for example first separator 224 or second separator 246, module. These performance counters log the number of occurrences of mailpiece hesitation defined as longer than half a second past nominal. Hence, the criteria in the motion profile is based on time. Mailpiece hesitation has proven to be a very early indicator of transport belt 248 contamination. Often, as the transport belt 248 builds up contamination, the mailpieces will momentarily hesitate. This hesitation is imperceptible by the operator. As the transport belt 248 progressively gets more contaminated, the incidence of hesitation increases, and jams result.

Other logs may contain information such as the mailpieces' physical characteristics such as length, height, and thickness. These other logs can be cross-linked with the performance counters for diagnostic purposes. Thus, the information from the separator performance counters can be cross-linked with information on the mailpieces that are being processed. This cross-linkage is valuable to determine whether any recoverable faults in the system are due to the mechanical degradation of the separator module or the mailpiece material. For example, hesitation can occur if thin cardstock mailpieces are being processed. Hesitation may also occur if the transport belt 240 is becoming contaminated. When the operator reviews the performance counter logs, the operator may determine that the separators 224, 246 are experiencing problems. By cross-linking the performance counter logs with other logs, then it may be shown that the hesitation is due to running thin cardstock rather than any break-down of the separators 224, 226. Thus, the operator can foresee any difficulties with the separators 224, 226

At step 400, the separator motion profile begins. At step 402, the motor used to drive the first separator 224 is initiated. At step 404, a timer that measures the time it takes a mailpiece to be transported from the nudger 218 to the first separator 224 starts. At step 406, a sensor 250 determines whether a mailpiece has left the nudger 218 and reached the reached the exit of the first separator 224 (this is the motion state). If the answer is yes, then the remainder of the first separator 224 motion profile continues (step 408). If the answer is no, then the motion profile continues to step 410. At step 410, the motion profile inquires whether a hesitation flag has been set. If so, the duration of the motion state is compared to the criteria for a jam (step 424). If the jam criteria is met, then a jam message is sent to the computer system 101 as in step 426. In step 428, the motion control processor 118 stops the first separator 224 module. If the hesitation flag has not been set, then the motion profile inquires whether the hesitation timeout has been exceeded; this is step 412. If so, then the hesitation flag is set at step 414. Then at step 416, the hesitation performance of the first separator 224 is incremented by one. The increment is also logged in step 416. Step 418 causes the motion control processor 118 to decelerate and stop the motor of the first separator 224. A delay of one hundred milliseconds begins in step 420. Pausing the motor at steps 418 and 420 allows the transport belt 248 to regain traction. At step 422, the first separator 224 is accelerated again. Step 424 continues the motion profile.

### eTrap Activation Performance Counter for Aligner Station Module

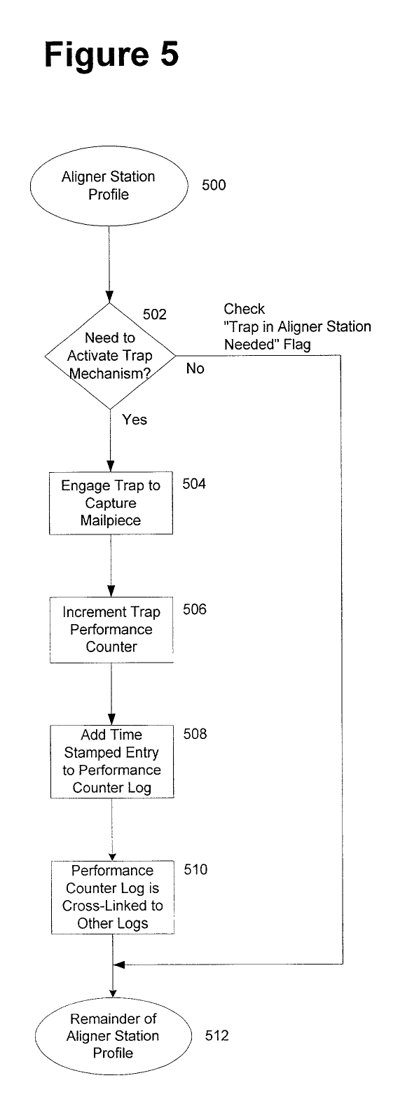

FIG. 5 depicts a trap activation performance counter for an aligner station 238. The trap 240 of the aligner station 238 is activated to capture short-length mailpieces when problems downstream are detected. In normal operation of the mixed mail feeder 200, the trap 240 module is a recoverable activation, affecting nothing but throughput.

The aligner station 238 profile begins at step 500. The motion state of the aligner station 238 is sent to the computer system 101. At step 502, the motion state is compared against the criteria established in the motion profile. Here the determination is based on whether the trap 240 mechanism needs to be activated. If so, the motion profile proceeds to step 504 which causes the motion control processor 118 to engage the trap 240 to capture the mailpiece. At step 506, the trap performance counter is incremented and logged. At step 508, a timestamp is added to the performance counter log. At step 510, the performance counter log is cross-linked to other logs from other modules. Then the motion profile proceeds with the remainder of the aligner station 238 motion profile as in step 512.

### Overheight Mailpiece Counter for the Aligner Station Module

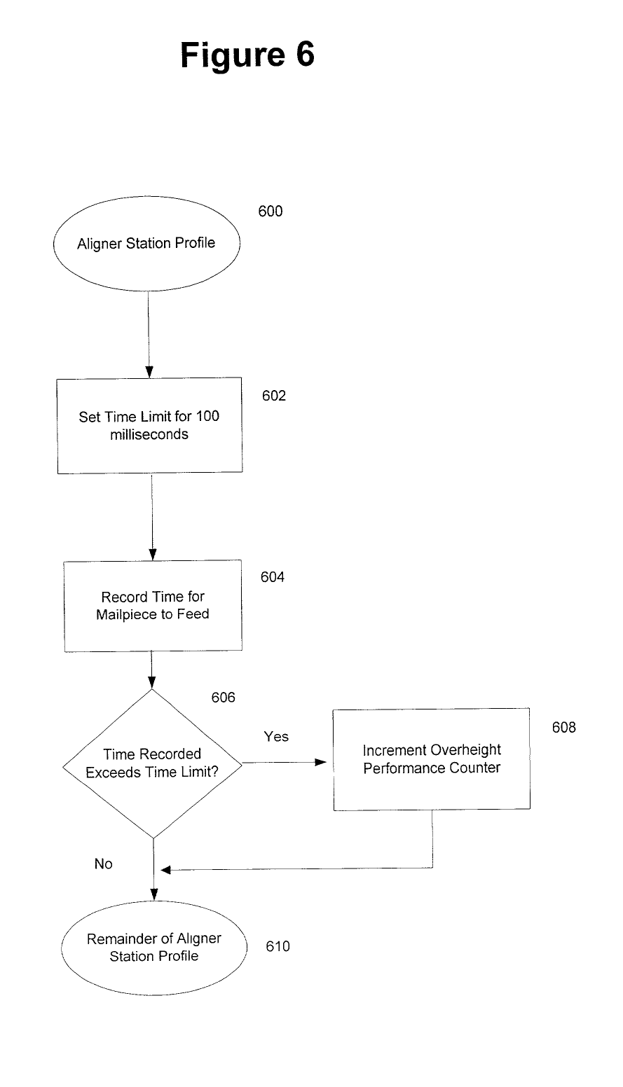

FIG. 6 depicts a skewed, overheight mailpieces performance counter for the aligner station 238. A maximum height for mailpieces is predetermined to ensure optimal performance of the mixed mail feeder. If a mailpiece is too high, then it runs the risk of jamming the system. A plurality of sensors, overheight sensors 250, can be placed near the nudger 218. Whenever a mailpiece is askew, that is the entire bottom edge of the mailpiece is not in contact with the belt 206, then the corner of the mailpiece of the side opposite the edge of the mailpiece not in contact with the transport belt 248 may trigger sensors 250. Thus, the sensors 250 are identifying overheight mailpieces.

At step 600, the aligner station 238 profile begins. A time limit of 100 milliseconds is set in step 602. At step 604, the time it takes a mailpiece to be fed through a sensor 250 in the aligner station 238 that detects height is recorded. At step 606, a decision is made as to whether the time recorded exceeds the time limit set in step 604. If not, the aligner station 238 profile continues. If the time limit is exceeded by the time recorded, then the overheight performance counter is incremented as in step 608. At step 610, the aligner station 238 profile continues. Thus, the overheight performance counter provides information that mailpieces are being fed askew, even if they are not skewed enough to stop the feeder. A threshold of greater than one percent of the number of mailpieces processed indicates that mailpiece skew is present. This information combined with a higher than normal number of stack advances due to lean means that the skew in the aligner station 238 is probably caused by mailpieces being pinned against the nudger 218 caused by improper loading of the mailpieces into the stack advance mechanism 204.

The performance counters of the present invention can also be employed in the following non-limiting examples:

### Performance Counters for Nudger Assistance Occurrences:

Sometimes a mailpiece may need to be jostled in order for the mailpiece to be properly fed through the mixed mail feeder. A performance counter can be utilized to provide a direct measurement of how many mailpieces required jostling of the stack of mixed mail 210 in order to be fed through. The criteria for this performance counter is based on mechanism retry. This mechanism retry will repeat up to the system timeout for the mixed mail feeder. When the number of faults in the log are compared to the log recording the number of jams that occurred, a determination can be made as to how many of the jostled mailpieces resulted in recoverable faults rather than jams.

### Stack Advance Lean Detection Counters/Stack Advance Nudger Feed Request Counters

This pair of counters records the number of stack advance activations requested by either the stack advance paddle 208 or stack lean sensor. For normal operation, the ratio of the stack advance paddle 208 to stack lean will be high, especially for jobs that have few flats. When the stack of mixed mail 210 is poorly loaded (excessive lean) or the stack advance mechanism 204 is having trouble keeping the stack vertical, this ratio will decrease. A ratio of less than five nudger 218 feed requests for every lean detect (count) initiated stack advance for letter mail indicates poor loading of the stack of mixed mail 210. Poor loading for flats exists if the ratio is less than three to one.

### Multi-feed Rate Performance Counters

Performance counters can be implemented to count the number of mailpieces separated at both the first separator 226 and second separator 246. These performance counters utilize cycle-related criteria. The multi-feed rate of the first separator 226 can be determined. Normally, the design of the first separator 226 is such that it will be allowed a higher multi-feed rate than the second separator 246, in exchange for handling the mailpieces with less force and thus less damage. The multi-feed rate can be expressed as an expected percentage. Any historical data exceeding this limit signifies a problem in the first separator 226. The concept has been extended to a reasonable approximation for the multi-feed rate out of the second separator 246. There is additional diagnostic information available, as well.

### Take Away Roller Assist Counters

These counters specifically measure ingestion delay occurrences in the first set of take away rollers 232, 234. When used in conjunction with the take away roller jam codes, insight can be gained as to where in the separator 226, 246 jams are originating. This type of counter helps to focus attention to where the jam originates, not where it ends.

### First Take Away Roller and Second Separator Gap Adjustment Counter

The mixed mail feeder must maintain a minimum time gap between successive mailpieces. In order to maximize the number of mailpieces that are processed at any given moment, the gap should be minimized as much as possible. These counters reflect the number of mailpieces that required gap correction at both the first set of take away rollers 232, 234 and the second separator 246 respectively. A high percentage of gap correction at the first set of take away rollers 232, 234 indicates possible stream-feeding at the first separator 226. A high percentage of gap corrections at the second separator 246 can be confirmation that the first separator 226 has a high multi-feed rate or an indication that the second separator 236 is delaying the mailpieces. A threshold of thirty percent for second separator 236 adjustments was determined to indicate a problem.

It is understood that, while the invention has been described in conjunction with the detailed description thereof, the foregoing description is intended to illustrate and not limit the scope of the invention, which is defined by the scope of the appended claims. Other aspects, advantages, and modifications are within the claims.

What is claimed is:

1. A system for gathering runtime information from a mail handling system comprising:
a component for maintaining a state in a mechanical system;
a component for incrementing a counter if said state meets criteria in a motion profile; and
a component for transferring counter data contained in said counter to a log.

2. A system of claim 1, further comprising a component for recording a timestamp when said state occurs in said log.

3. A system of claim 1, further comprising a component for cross-linking said counter data to system data.

4. A system of claim 1, wherein said mechanical system is a mixed mail feeder.

5. A system of claim 1, wherein said criteria is a function of time.

6. A system of claim 1, wherein said criteria is a function of mechanism retry.

7. A system of claim 1, wherein said criteria is a function of cycle.

8. A system of claim 1, wherein said state is nudger retry.

9. A system of claim 1, wherein said state is separator hesitation.

10. A system of claim 1, wherein said state is overheight mailpiece.

11. A system of claim 1, wherein said state is trap activation.

12. A system for gathering runtime information from a mail handling system comprising:
a component for maintaining a state in a mechanical system;
a component for identifying a module corresponding to said state by a motion control processor;
a component for incrementing a counter if said state meets criteria in a motion profile;
a component for transferring counter data contained in said counter to a log; and
a component for transferring system data regarding said module to said log.

13. A system of claim 12, further comprising a component for recording a timestamp when said state occurs in said log.

14. A system of claim 12, further comprising a component for cross-linking said counter data to said system data.

15. A system of claim 12, wherein said mechanical system is a mixed mail feeder.

16. A system of claim 12, wherein said module is a nudger.

17. A system of claim 12, wherein said module is an aligner station.

18. A system of claim 12, wherein said module is a separator.

19. A system of claim 12, wherein said module is a stack advance mechanism.

20. A system of claim 12, wherein said state is nudger retry.

21. A system of claim 12, wherein said state is separator hesitation.

22. A system of claim 12, wherein said state is overheight mailpiece.

23. A system of claim 12, wherein said state is trap activation.

24. A method for gathering runtime information from a mail handling system comprising the steps of:
maintaining a state in a mechanical system;
incrementing a counter if said state meets criteria in a motion profile; and
transferring counter data contained in said counter to a log.

25. A method of claim 24, further comprising the step of recording a timestamp when said state occurs in said log.

26. A system of claim 24, further comprising the step of cross-linking said counter data to system data.

27. A method of claim 24, wherein said mechanical system is a mixed mail feeder.

28. A method of claim 24, wherein said criteria is a function of time.

29. A method of claim 24, wherein said criteria is a function of mechanism retry.

30. A method of claim 24, wherein said criteria is a function of cycle.

31. A system of claim 24, wherein said state is nudger retry.

32. A system of claim 24, wherein said state is separator hesitation.

33. A system of claim 24, wherein said state is overheight mailpiece.

34. A system of claim 24, wherein said state is trap activation.

35. A method for gathering runtime information from a mail handling system comprising the steps of:
maintaining a state in a mechanical system;
identifying a module corresponding to said state by a motion control processor;
incrementing a counter if said state meets criteria in a motion profile;
transferring counter data contained in said counter to a log; and
transferring module information regarding said module to said log.

36. A method of claim 35, further comprising the step of recording a timestamp when said state occurs in said log.

37. A method of claim 35, further comprising the step of cross-linking said counter data to said module information.

38. A method of claim 35, wherein said mechanical system is a mixed mail feeder.

39. A method of claim 35, wherein said module is a nudger.

40. A method of claim 35, wherein said module is an aligner station.

41. A method of claim 35, wherein said module is a separator.

42. A method of claim 35, wherein said module is a stack advance mechanism.

43. A system of claim 35, wherein said state is nudger retry.

44. A system of claim 35, wherein said state is separator hesitation.

45. A system of claim 35, wherein said state is overheight mailpiece.

46. A system of claim 35, wherein said state is trap activation.
